(19) United States
(12) Patent Application Publication
(10) Pub. No.: US 2009/0289977 A1
(43) Pub. Date: Nov. 26, 2009

(54) LIQUID DELIVERY DEVICE, ELECTRICAL CIRCUIT, AND LIQUID JETTING SYSTEM

(76) Inventor: Noboru Asauchi, Nagano-ken (JP)

Correspondence Address: STROOCK & STROOCK & LAVAN LLP, 180 MAIDEN LANE, NEW YORK, NY, 10038, US

(21) Appl. No.: 12/467,921

(22) Filed: May 18, 2009

(30) Foreign Application Priority Data
May 26, 2008 (JP) 2008-136738

(51) Int. Cl. B41J 29/38

(52) U.S. Cl. 347/10

(57) ABSTRACT

The liquid delivery device adapted for installation in a liquid jetting device that has a number N of liquid receiving portions, where N is an integer equal to 2 or greater, comprises an electrical device that returns a response signal in response to a driving signal from the liquid jetting device; a number N of liquid delivery portions that deliver liquid to the liquid receiving portions; and a number N of sets of terminals provided in correspondence with the liquid delivery portions; wherein the electrical device receives the driving signal and transmits the response signal, via one set of terminals among a number M of sets of terminals among the N sets of terminals, where M is an integer equal to 2 or greater but not greater than N.

### CROSS-REFERENCE TO RELATED APPLICATION

The present application claims the priority based on Japanese Patent Application No. 2008-136738 filed on May 26, 2008, the disclosure of which is hereby incorporated by reference in its entirety.

### BACKGROUND

1. Technical Field

The present invention relates to a liquid delivery device, an electrical circuit, and a liquid jetting system.

2. Related Art

Inkjet printers and other such devices (printers) that are adapted to record information by ejecting ink onto paper currently enjoy widespread use. A printer of this kind will typically have one or more ink cartridges containing ink, installed for the purpose of delivering ink to the printer. Management of remaining ink level is a crucial technology in the field of printers. Management of ink usage has been implemented not just through counting by a software application installed on the printer end, but more recently by providing a sensor to the ink cartridge itself so that ink level can be measured directly. For example, some known technologies employ a piezoelectric element as a sensor for sensing remaining ink level (see JP 2001-147146 A for example).

However, one problem with ink cartridges that are equipped with a sensor is that providing the sensor entails an increased number of parts. An additional problem is that if an ink cartridge lacking an on-board sensor is installed in a printer that is intended for use with sensor-equipped ink cartridges, the printer will not be able to operate, since it will not receive the normal response signals from the ink cartridge. Such problems are not limited to ink cartridges for use in inkjet printers, but are common to liquid delivery devices such as liquid receptacles adapted for installation on liquid jetting devices, and to systems employing these.

### SUMMARY

It is accordingly an object of the invention to achieve a reduction in the number of parts while maintaining normal operation, in a liquid delivery device that is adapted for installation in a liquid jetting device intended for use with sensor-equipped liquid delivery devices.

In order to address the above problems at least in part, the liquid delivery device according to a first aspect of the invention resides in a liquid delivery device adapted for installation in a liquid jetting device that has a number N of liquid receiving portions, where N is an integer equal to 2 or greater, and comprising: an electrical device that returns a response signal in response to a driving signal from the liquid jetting device; a number N of liquid delivery portions that deliver liquid to the liquid receiving portions; and a number N of sets of terminals provided in correspondence with the liquid delivery portions; wherein the electrical device receives the driving signal and transmits the response signal, via one set of terminals among a number M of sets of terminals among the N sets of terminals, where M is an integer equal to 2 or greater but not greater than N.

With this arrangement, in a liquid delivery device that is adapted for installation in a liquid jetting device intended for use with sensor-equipped liquid delivery devices, a reduction in the number of parts may be achieved while maintaining normal operation.

In a possible arrangement in the liquid delivery device of the above aspect, the M sets of terminals are electrically connected in parallel to the electrical device. A simpler configuration can be afforded thereby.

In another possible arrangement, the liquid delivery device of the above aspect further comprises switches that selectively connect one set of the M sets of terminals to the electrical device. With this arrangement, in an ink delivery device for a liquid jetting device that is not compatible with simple parallel connections, a reduction in the number of parts may be achieved while maintaining normal operation.

In yet another possible arrangement, the liquid delivery device of the above aspect further comprises switches that produce a state of electrical continuity between the electrical device and one selected set of terminals among the M sets of terminals, while producing a state of electrical discontinuity between the electrical device and the other of the M sets of terminals. With this arrangement, in an ink delivery device for a liquid jetting device that is not compatible with simple parallel connections, a reduction in the number of parts may be achieved while maintaining normal operation.

In yet another possible arrangement in the liquid delivery device of the above aspect, the electrical device includes a sensor-simulating circuit that, without sensing whether liquid is present in the liquid delivery portions, will output a signal indicating that liquid is present in the liquid delivery portions as the response signal. With this arrangement, the sensor can be replaced with a simple sensor-simulating circuit so as to afford a simpler configuration and reduced number of parts of the liquid delivery device.

In yet another possible arrangement in the liquid delivery device of the above aspect, the sensor-simulating circuit includes an oscillator circuit. With this arrangement, it will be possible to easily devise a sensor-simulating circuit for use in place of a sensor employing a piezoelectric element, for example.

In yet another possible arrangement in the liquid delivery device of the above aspect, the electrical device includes a sensor that outputs different signals as the response signal, depending on whether the liquid is present in the liquid delivery portion. With this arrangement, because a single sensor functions in a virtual manner as a sensor for a plurality of liquid delivery portions, in a liquid delivery device that is adapted for installation in a liquid jetting device intended for use with sensor-equipped liquid delivery devices, a reduction in the number of parts may be achieved while maintaining normal operation.

In yet another possible arrangement in the liquid delivery device of the above aspect, the sensor includes a piezoelectric element. Through this arrangement there can be devised a sensor that is adapted to sense the presence or absence of liquid according to the characteristics of the oscillating element of the piezoelectric element.

In yet another possible arrangement in the liquid delivery device of the above aspect, wired connections are provided between the electrical device and a first set of terminals among the M sets of terminals, and between the electrical device and a second set of terminals among the M sets of terminals; and wiring length between the electrical device and the first set of terminals is equal to wiring length between the electrical device and the second set of terminals. With this arrangement, equivalent connections can be made from the electrical device to the first set of terminals and the second set of terminals.

In yet another possible arrangement in the liquid delivery device of the above aspect, the number M is equal to the number N, and the electrical device individually receives the drive signal and transmits the response signal, via any one set of terminals among the N sets of terminals. With this arrangement, a single electrical device will suffice for N sets of terminals, so the number of parts can be reduced.

The present invention may be embodied in a number of possible aspects, for example, an electrical circuit adapted for installation in a liquid jetting device that has a number N of liquid receiving portions, and a number N of sets of device-side terminals provided in correspondence with the liquid receiving portions, where N is an integer equal to 2 or greater. The present invention may also be embodied as a liquid jetting system comprises a liquid jetting device and a liquid delivery device adapted to be installed in the liquid jetting device.

These and other objects, features, aspects, and advantages of the invention will become more apparent from the following detailed description of the preferred embodiments with the accompanying drawings.

### BRIEF DESCRIPTION OF THE DRAWINGS

FIG. 1 is an illustration depicting a general configuration of a printing system of Embodiment 1;

FIG. 2 is a diagram depicting the exterior configuration of an ink delivery device;

FIGS. 3A and 3B are diagrams illustrating a board of a first type;

FIG. 4 is a diagram showing an electrical configuration of an oscillator circuit;

FIGS. 5A and 5B are diagrams illustrating a board of a second type;

FIG. 6 is an illustration depicting wiring arrangements on the back side of a board of the first type and boards of the second type;

FIG. 7 is a first illustration of an electrical configuration of a printing system in Embodiment 1;

FIG. 8 is a second illustration of the electrical configuration of the printing system in Embodiment 1;

FIG. 9 is a timing chart of an instance of frequency measurement of a response signal RS in Embodiment 1;

FIG. 10 is an illustration depicting an electrical configuration of a printing system in a comparative example;

FIG. 11 is a diagram depicting an electrical configuration of a printer in Embodiment 2;

FIG. 12 is a first timing chart in the case of measurement of response signal RS frequency in Embodiment 2;

FIG. 13 is an illustration depicting a configuration of an ink delivery device 100A in Embodiment 2; and

FIG. 14 is a second timing chart in the case of measurement of response signal RS frequency in Embodiment 2.

### DESCRIPTION OF THE PREFERRED EMBODIMENTS

### A. Embodiment 1

### Printing System Configuration:

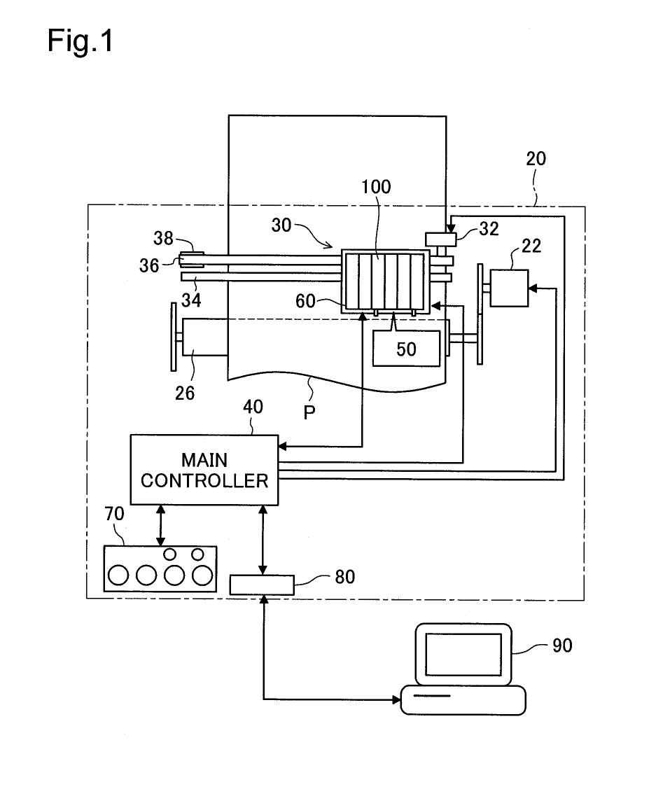

The modes of the present invention will be described through certain preferred embodiments. FIG. 1 is an illustration depicting a general configuration of a printing system of Embodiment 1. The printing system comprises a printer 20, a computer 90, and an ink delivery device 100. The printer 20 is connected to the computer 90 via a connector 80.

The printer 20 comprises a sub-scan feed mechanism, a main scan feed mechanism, a head driving mechanism, and a main controller 40 for controlling these mechanisms. The sub-scan feed mechanism includes a paper feed motor 22 and a platen 26; rotation of the paper feed motor 22 is transmitted to the platen 26 in order to feed paper P in the sub-scanning direction. The main scan feed mechanism includes a carriage motor 32; a pulley 38; a drive belt 36 stretched between the carriage motor 32 and the pulley 38; and a slide rail 34 disposed parallel to the axis of the platen 26. The slide rail 34 slidably retains a carriage 30 that is affixed to the drive belt 36. Rotation of the carriage motor 32 is transmitted to the carriage 30 via the drive belt 36 so that the carriage 30 undergoes reciprocating motion along the slide rail 34 in the axial direction of the platen 26 (main scanning direction). The head driving mechanism includes a print head unit 60 that is carried on the carriage 30, and is adapted to drive the print head and eject ink onto the paper P. The print head unit 60 can accommodate detachable installation of a plurality of ink cartridges, as will be discussed later. The printer 20 is additionally comprises a control portion 70 allowing the user to make various printer settings or to check the status of the printer.

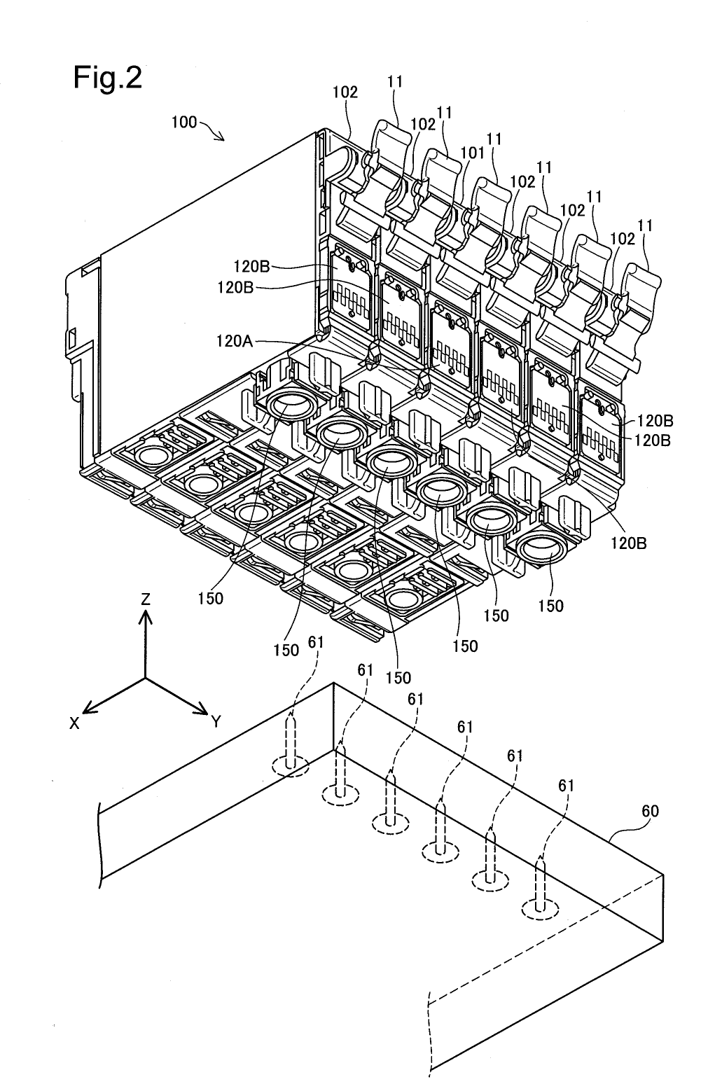

FIG. 2 is a diagram depicting the exterior configuration of the ink delivery device 100. The ink delivery device 100 includes an ink cartridge 101 of a first type, and five ink cartridges 102 of a second type. These six ink cartridges 101, 102 are unified by being bonded together at their mutually adjacent side faces (faces situated to the sides in the Y axis direction). Each ink cartridge will contain ink of a different color, for example. Each ink cartridge may contain for example one color among inks of six colors, e.g. inks of the four basic colors cyan (C), magenta (M), yellow (Y), and black (K), plus light cyan (LC) and light magenta (LM). Ink delivery ports 150 respectively open at the bottom face (the face lying towards the negative direction along the Z axis) of each of the ink cartridges 101, 102. A board 120A of a first type is positioned to the lower side of the front face (the face lying towards the negative direction along the X axis) of the ink cartridge 101 of the first type. A board 120B of a second type is positioned to the lower side of the front face (the face lying towards the negative direction along the X axis) of each of the ink cartridges 102 of the second type.

The ink delivery device 100 is detachably installed on the print head unit 60. A holder (not shown) for securing the ink delivery device 100 is arranged on top of the print head unit 60. The ink delivery device 100 is secured to the top of the print head unit 60 through engagement of hook portions 11 provided on the ink delivery device 100 with hook portions provided on the holder. A carriage circuit 50 (FIG. 1) is mounted onto the holder; when the ink delivery device 100 has been installed on the print head unit 60, the terminals of the boards 120A, 120B of the ink delivery device 100 will electrically connect to the carriage circuit 50. The carriage circuit 50 is a circuit adapted to carry out control in relation to the ink cartridges in cooperation with the main controller 40, and will hereinbelow also be referred to as a sub-controller.

Six ink receiving needles 61 are arranged on the upper face of the print head unit 60 of the printer 20. When the ink delivery device 100 has been installed on the print head unit 60, the ink receiving needles 61 will respectively insert into the corresponding ink delivery ports 150. Ink is delivered to the printer 20 from the interior of the ink cartridges 101, 102 of the ink delivery device 100 via the ink receiving needles 61. The print head unit 60 includes a plurality of nozzles and a plurality of piezoelectric elements, and is adapted to eject droplets of ink from the nozzles in response to application of voltage to these piezoelectric elements, thereby forming dots on the paper P.

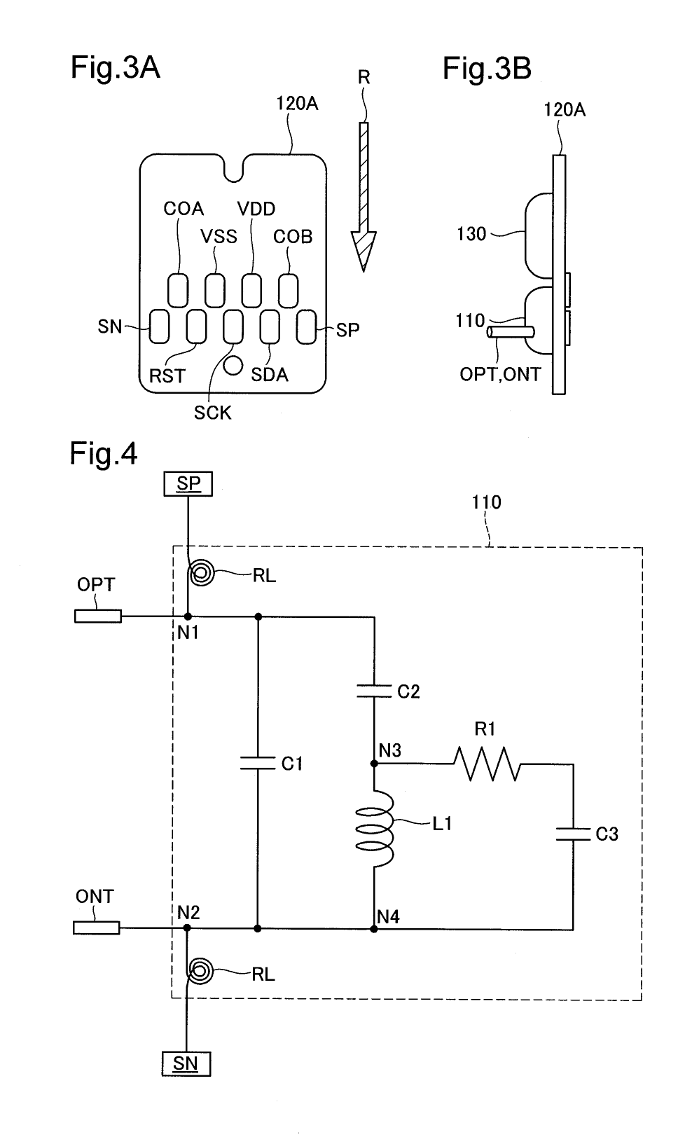

FIGS. 3A and 3B are diagrams illustrating the board of the first type 120A. Nine terminals are arranged on the front face of the board of the first type 120A. A storage device 130 and an oscillator circuit 110 are arranged on the back face of the board of the first type 120A. The storage device 130 is a rewritable nonvolatile memory, such as EEPROM (Electronically Erasable and Programmable Read Only Memory) for example.

The nine terminals on the front face of the board of the first type 120A are generally oblong in shape and arranged to form two rows generally perpendicular to the insertion direction R. The insertion direction R indicates the direction of insertion of the ink delivery device 100 when installed in (the holder of) the print head unit 60. Of the two rows, the row lying towards the insertion direction R, i.e. towards lower side in FIG. 3A, will be termed the lower row, and the row lying to the opposite side from the insertion direction R, i.e. towards upper side in FIG. 3A, will be termed the upper row. The terminals that make up the upper row and the terminals that make up the lower row are arranged differently from one another in a staggered arrangement such that the terminal centers do not line up with one another in the insertion direction R.

The terminals which are arrayed to make up the upper row are, in order from the left side, a first cartridge out terminal COA, a ground terminal VSS, a power supply terminal VDD, and a second cartridge out terminal COB. The terminals which are arrayed to make up the lower row are, in order from the left side, a first oscillator circuit terminal SN, a reset terminal RST, a clock terminal SCK, a data terminal SDA, and a second oscillator circuit terminal SP. The electrical configuration of the terminals will be discussed later. Of these terminals, the ground terminal VSS, the power supply terminal VDD, the reset terminal RST, the clock terminal SCK, and the data terminal SDA are terminals for memory use, and are electrically connected to the storage device 130. The first cartridge out terminal COA is shorted to the ground terminal VSS, and is used by the printer 20 to detect whether an ink cartridge has been installed. The first oscillator circuit terminal SN and the second oscillator circuit terminal SP are electrically connected to the oscillator circuit 110, discussed later.

FIG. 4 is a diagram of the electrical configuration of the oscillator circuit 110. A first input/output node N1 of the oscillator circuit 110 is electrically connected, via a wire length adjustment portion RL, to the first oscillator circuit terminal SN of the board of the first type 120A onboard the oscillator circuit 110. The first input/output node N1 is also electrically connected to a first external connection terminal ONT. A second input/output node N2 is electrically connected, via a wire length adjustment portion RL, to the second oscillator circuit terminal SP of the board of the first type 120A onboard the oscillator circuit 110. The second input/output node N2 is also electrically connected to a second external connection terminal OPT. As shown in FIG. 3B, the first external connection terminal ONT and the second external connection terminal OPT project out from the back side of the board of the first type 120A.

The oscillator circuit 110 includes capacitors C1, C2, C3, a resistor R1, and a coil L1. The first capacitor C1 is situated between the first input/output node N1 and the second input/output node N2. The second capacitor C2 and the coil L1 are connected in series. The series-connected second capacitor C2 and coil L1 are situated parallel to the first capacitor C1 and between the first input/output node N1 and the second input/output node N2. The resistor R1 and the third capacitor C3 connected in series. The series-connected resistor R1 and third capacitor C3 are situated parallel to the coil L1, and between a node N3 and a node N4.

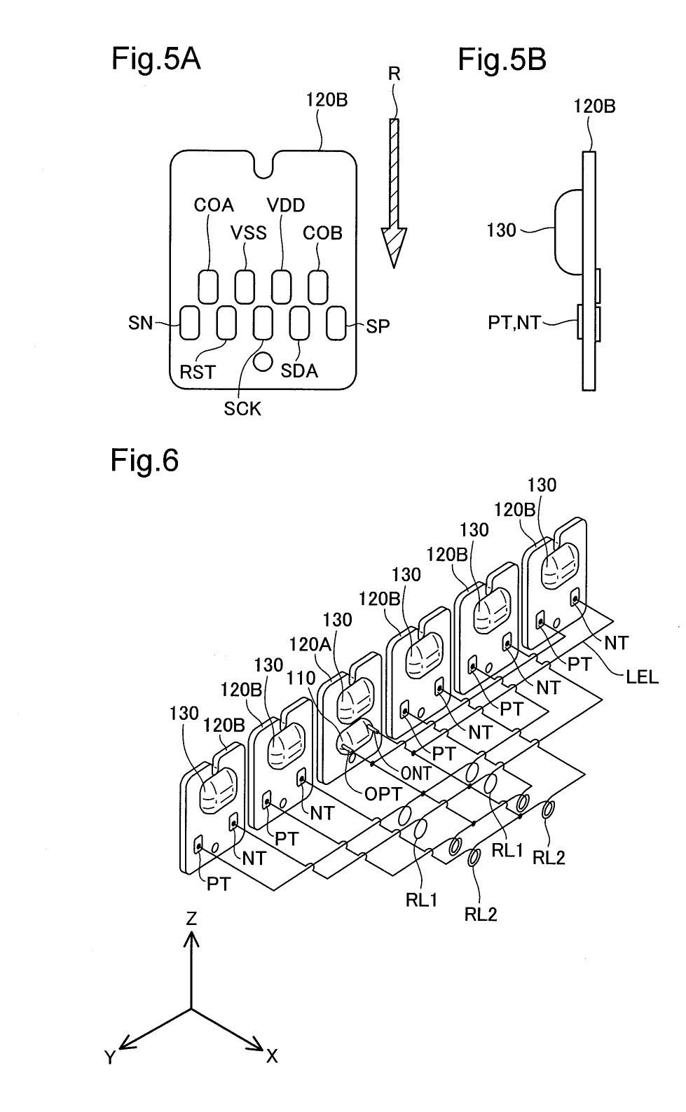

FIGS. 5A and 5B are diagrams illustrating the board of the second type 120B. Like the front face of the board of the first type 120A, the front face of the board of the second type 120B has nine terminals arranged thereon. On the back face of the board of the second type 120B are arranged a storage device 130 and two oscillator circuit connection terminals PT, NT. Of the nine terminals, the ground terminal VSS, the power supply terminal VDD, the reset terminal RST, the clock terminal SCK, and the data terminal SDA are terminals for memory use, and are electrically connected to the storage device 130. The first cartridge out terminal COA is shorted to the ground terminal VSS, and is used to sense whether an ink cartridge has been installed in the printer 20. The first oscillator circuit terminal SN is electrically connected to the first oscillator circuit connection terminal NT, while the second oscillator circuit terminal SP is electrically connected to the second oscillator circuit connection terminal PT.

FIG. 6 is an illustration depicting wiring arrangements on the back side of the board 120A of the first type and boards 120B of the second type. The first oscillator circuit connection terminal NT of each board of the second type 120B is electrically connected to a first external connection terminal ONT of the oscillator circuit 110 of the board of the first type 120A. Here, the first oscillator circuit connection terminal NT of the board of the second type 120B situated at the right end in FIG. 6, i.e. the board of the second type 120B that is the furthest distance away from the board of the first type 120A, is connected to the first external connection terminal ONT directly rather than via a wire length adjustment portion. On the other hand, the first oscillator circuit connection terminals NT of the other boards 120B of the second type are connected to the first external connection terminal ONT via wire length adjustment portions RL1 or RL2 according to their distance from the board of the first type 120A. As a result, wire lengths from the first oscillator circuit connection terminal NT of each of the boards 120B of the second type to the first external connection terminal ONT will be adjusted to equal lengths.

Similarly, the second oscillator circuit connection terminal PT of each board of the second type 120B is electrically connected to a second external connection terminal OPT of the oscillator circuit 110. The second oscillator circuit connection terminal PT of the board of the second type 120B situated at the right end in FIG. 6 is connected to the second external connection terminal OPT directly rather than via a wire length adjustment portion. On the other hand, the second oscillator circuit connection terminals PT of the other boards 120B of the second type are connected to the second external connection terminal OPT via wire length adjustment portions RL1 or RL2 according to their distance from the board of the first type 120A. As a result, wire lengths from the second oscillator circuit connection terminal PT of each of the boards of the second type 120B to the second external connection terminal OPT will be adjusted to equal lengths.

As a result of being connected in this way, the oscillator circuit 110 will appear as being parallel-connected equivalently, to the first and second oscillator circuit terminals SN, SP on the back side of each board of the second type 120B. The wire length adjustment portions RL in FIG. 4 are designed with length adjusted in such a way that the oscillator circuit 110 as it appears to the first and second oscillator circuit terminals SN, SP on the back side of the board of the first type 120A will be equivalent to the oscillator circuit 110 as it appears to the first and second oscillator circuit terminals SN, SP on the back side of boards of the second type 120B. Consequently, the oscillator circuit 110 will appear to be parallel-connected equivalently to the first and second oscillator circuit terminals SN, SP of all of the boards 120A, 102B.

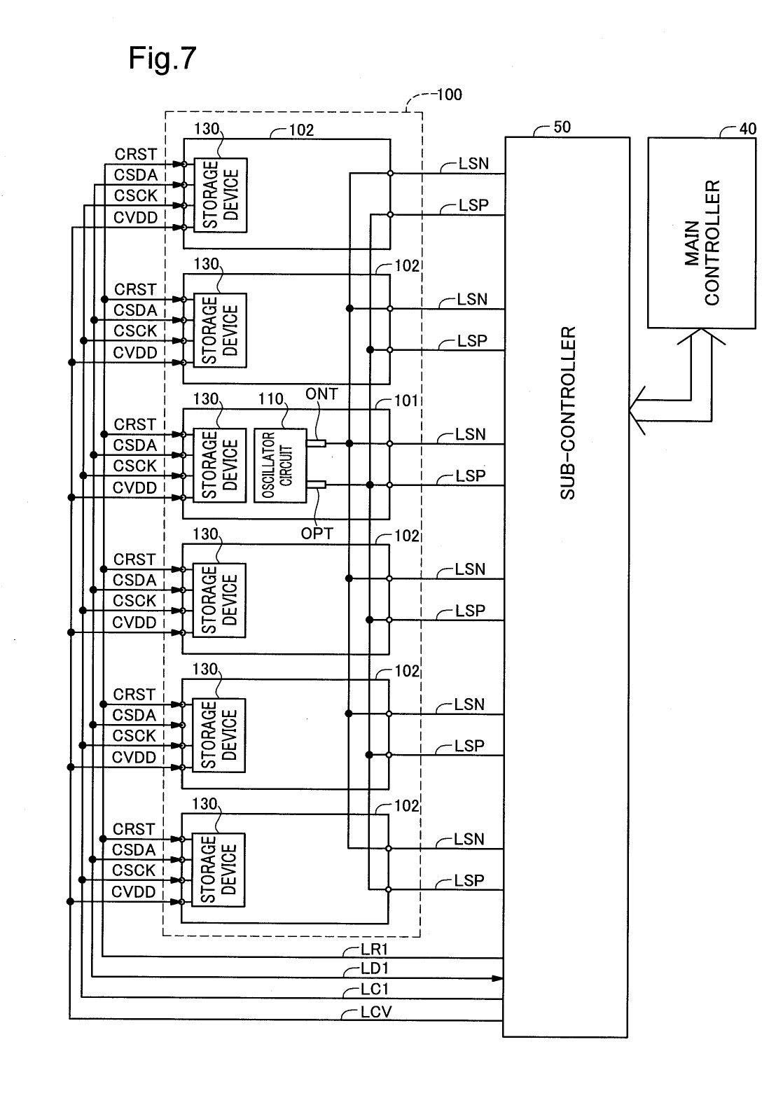

FIG. 7 is a first illustration of an electrical configuration of the printing system in Embodiment 1. FIG. 7 depicts the main controller 40, the sub-controller 50, and the ink delivery device 100 in their entirety. The storage devices 130 of the ink cartridges 101, 102 that make up the ink delivery device 100 are assigned mutually different 3-bit ID numbers (identification numbers). Where the total number of installed ink cartridges 101, 102 is six, the six storage devices 130 will be respectively assigned IDs from “001” to “110” for example.

The sub-controller 50 and the ink cartridges 101, 102 are interconnected by a plurality of lines. The plurality of lines include a reset signal line LR1, a data signal line LD1, a clock signal line LC1, a first sensor signal line LSN, a second sensor signal line LSP, and a power supply line LCV.

The reset signal line LR1, the data signal line LD1, the clock signal line LC1, and the power supply line LCV are respectively conductive lines for transmitting a reset signal CRST, a data signal CSDA, a clock signal CSCK, and power supply potential CVDD; these are electrically connected to the storage devices 130 via the reset terminal RST, the data terminal SDA, the clock terminal SCK, and the power supply terminal VDD of the boards 120A, 120B. Using these lines LR1, LD1, LC1, LCV, the sub-controller 50 is able to access the storage devices 130. Similarly, the ground line for supplying ground potential GND via the ground terminal VSS, and the installation sensing terminal for transmitting via the first cartridge out terminal COA a signal for sensing whether a cartridge is installed, are wired between the sub-controller 50 and the ink cartridges 101, 102; however, these have been omitted in FIG. 7 in order to avoid a complicated drawing. As the power supply voltage CVDD there is used potential of about 3.3 V versus the low level ground potential CVSS (GND level). The potential level of the power supply voltage CVDD could be a different potential, e.g. 1.5 V or 2.0 V, depending on factors such as the processor generation of the storage devices 130.

One set including a first sensor signal line LSN and a second sensor signal line LSP is wired to each of the ink cartridges 101, 102. When the print head unit 60 is installed in the ink delivery device 100, the first oscillator signal line SN of the board 120A or 120B and the sub-controller 50 will be electrically connected via the first sensor signal line LSN. When the print head unit 60 is installed in the ink delivery device 100, the second oscillator signal line SP of the board 120A or 120B and the sub-controller 50 will be electrically connected via the second sensor signal line LSP.

The main controller 40 and the sub-controller 50 are connected by a bus BS so as to enable transmission of various signals and data.

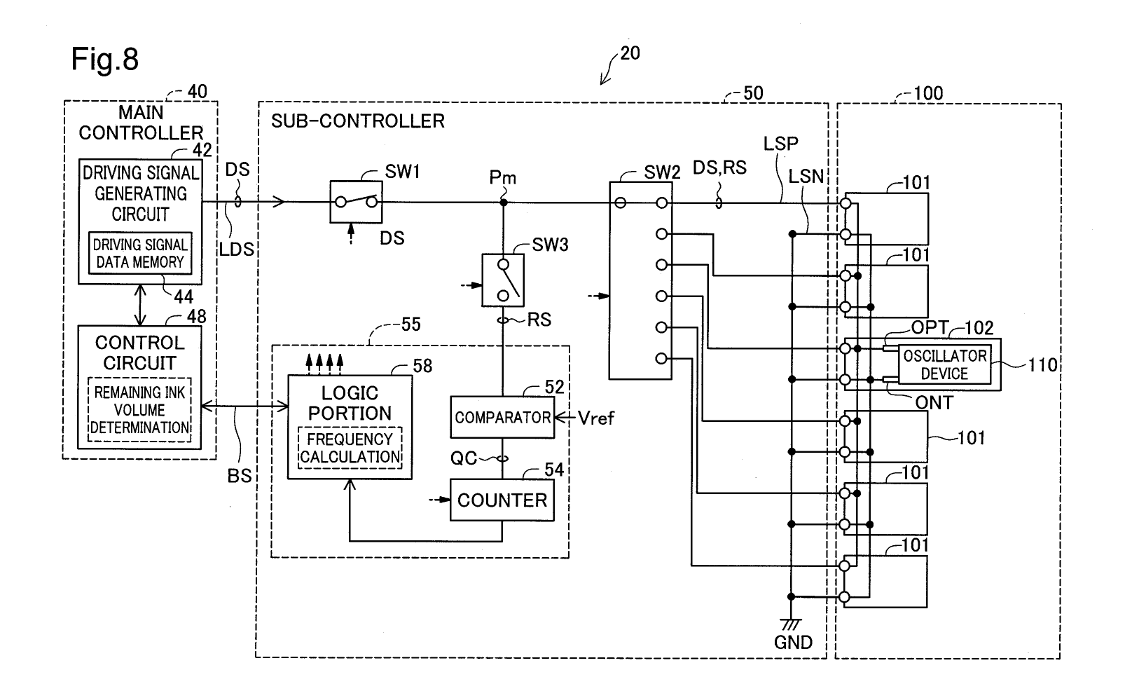

FIG. 8 is a second illustration of the electrical configuration of the printing system in Embodiment 1. FIG. 8 depicts primarily the parts needed to determine remaining ink volume. The main controller 40 includes a driving signal generating circuit 42, and a first control circuit 48 that includes a CPU and memory.

The driving signal generating circuit 42 includes a driving signal data memory 44. The driving signal data memory 44 stores data that represents a sensor driving signal DS for driving the sensor. In accordance with an instruction from the first control circuit 48, the driving signal generating circuit 42 will read data from the driving signal data memory 44, and generate the sensor driving signal DS having an prescribed waveform.

In the present embodiment, the driving signal generating circuit 42 can additionally generate a head driving signal for presentation to the print head unit 60. That is, in the present embodiment, during execution of determination of remaining ink volume the first control circuit 48 will cause the signal generating circuit 42 to generate the sensor driving signal; while during execution of printing it will cause the signal generating circuit 42 to generate the head driving signal.

The sub-controller 50 includes three kinds of switches SW1 to SW3, and a second control circuit 55. The second control circuit 55 includes a comparator 52, a counter 54, and a logic portion 58. The logic portion 58 controls operation of the switches SW1 to SW3 and the counter 54. In the present embodiment, the logic portion 58 is composed of a single chip (ASIC).

The first switch SW1 is a single-channel analog switch. One terminal of the first switch SW1 is connected to the signal generating circuit 42 of the main controller 40 via a third sensor driving signal line LDS, while the other terminal is connected to the second and third switches SW2, SW3. The first switch SW1 will be set to the On state during presentation of the sensor driving signal DS to the oscillator circuit 110, and will be set to the Off state during reception of a response signal RS from the oscillator circuit 110.

The second switch SW2 is a six-channel analog switch. The terminal on one side of the second switch SW2 is connected to the first and third switches SW1, SW3. The six terminals on the other side of the second switch SW2 will respectively connect with the first oscillation signal terminals SN of the ink cartridges 101, 102 via the first sensor signal lines LSN when the ink delivery device 100 is installed in the print head unit 60.

When the ink delivery device 100 has been installed in the print head unit 60, the second oscillation signal terminals SP of the ink cartridges 101, 102 that make up the ink delivery device 100 will be presented with ground potential GND.

The third switch SW3 is a single-channel analog switch. One terminal of the third switch SW3 is connected to the first and second switches SW1, SW2, while the other terminal is connected to the comparator 52 of the second control circuit 55. The third switch SW3 will be set to the Off state during presentation of the sensor driving signal DS to the oscillator circuit 110, and will be set to the On state during reception of the response signal RS from the oscillator circuit 110.

The comparator 52 includes an op amp, and is adapted to compare a reference voltage Vref with the response signal RS presented to it via the third switch SW3, and outputs a signal QC indicating the outcome of the comparison. Specifically, the comparator 52 will bring the output signal QC to H level if the voltage of the response signal RS is equal to or greater than the reference voltage Vref, or bring the output signal QC to L level if the voltage of the response signal RS is less than the reference voltage Vref.

The counter 54 will count the number of pulses contained in the output signal QC from the comparator 52, and will provide the count value to the logic portion 58. The counter 54 executes the count operation during intervals in which it is to the enabled state by the logic portion 58.

The logic portion 58 controls the second switch SW2 and selects one target for sensing from among the six ink cartridges 101, 102. When presenting a driving signal to the oscillator circuit 110, the logic portion 58 will set the first switch SW1 to the On state, and set the third switch SW3 to the Off state. When sensing a response signal from the oscillator circuit 110, the logic portion 58 will set the first switch SW1 to the Off state, and set the third switch SW3 to the On state.

During the interval that the response signal from the oscillator circuit 110 is to be sensed, the logic portion 58 will set the counter 54 to the enabled state. Then, utilizing the count value of the counter 54, the logic portion 58 will measure the time (measurement interval) needed for a prescribed number of pulses included in the output signal QC from the comparator 52 to be produced. Specifically, an oscillator (not shown) is provided internally to the sub-controller 50, and the measurement interval is measured utilizing a clock signal that is output by the oscillator. Then, on the basis of the measurement interval and the number of pulses of the output signal QC output by the counter, logic portion 58 will calculate the frequency Hc of the response signal RS. The frequency Hc of the response signal will be equal to the frequency of oscillation of the oscillator circuit 110 in response to the driving signal DS. The calculated frequency Hc will be presented to the first control circuit 48 of the main controller 40.

Based on the calculated frequency Hc, the first control circuit 48 of the main controller 40 will decide whether the remaining ink volume in the selected ink cartridge 101, 102 is equal to or greater than a prescribed volume. Specifically, if the calculated frequency Hc is substantially equal to a first oscillation frequency H1, it will be decided that the remaining ink volume is equal to or greater than the prescribed volume; whereas if it is substantially equal to a second oscillation frequency H2, it will be decided that the remaining ink volume is less than the prescribed volume.

Here, the oscillator circuit 110 of the present embodiment is designed in such a way that the response signal RS of frequency substantially equal to the oscillation frequency H1 will be returned in response to the sensor driving signal DS. Specifically, the characteristics of the capacitors C1 to C3, the coil L1, and the resistor R1 will be set experimentally so that the circuit oscillates at a frequency substantially equal to the oscillation frequency H1 in response to input of the sensor driving signal DS.

As will be appreciated from the above, the main controller 40 and the sub-controller 50 cooperate to determine remaining ink volume in each ink cartridge. In the present embodiment, the first control circuit 48 of the main controller 40 will always decide that the remaining ink volume is equal to or greater than the prescribed volume, for all of the ink cartridges 101, 102. As a result, the main controller will carry out printing operations on the assumption that ink is always present in each of the ink cartridges 101, 102 of the ink delivery device 100. Consequently, with the ink delivery device 100 of the present embodiment, management of remaining ink volume will be left up to the user. In the ink delivery device 100, refill holes for refilling ink are provided on the top faces of the ink cartridges 101, 102 for example. The user will for example replenish the ink cartridges 101, 102 with ink through the refill holes as needed in order to constantly maintain the ink cartridges 101, 102 in an ink-filled state.

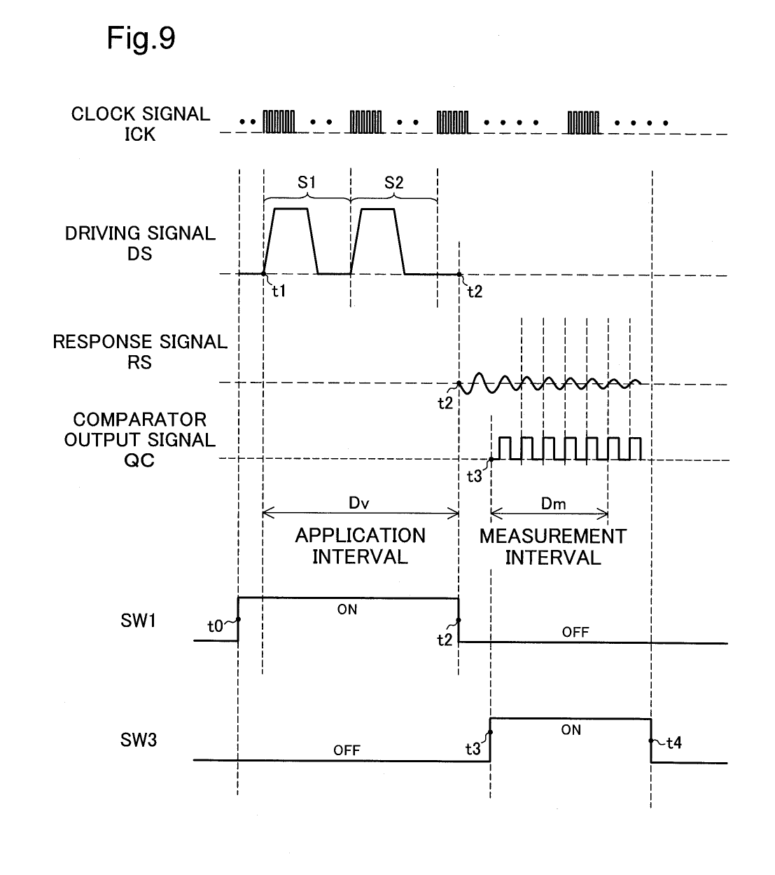

FIG. 9 is a timing chart of an instance of frequency measurement of the response signal RS in Embodiment 1. In FIG. 9, a clock signal ICK, the driving signal DS, the response signal RS, and the comparator output signal QC are shown. The clock signal ICK represents the output of the internal oscillator (not shown) of the sub-controller 50. The driving signal DS and the response signal RS are signals measured at point Pm in FIG. 8.

Also shown in FIG. 9 is a timing chart of operation of the first switch SW1 and the third switch SW3.

The sub-controller 50 will carry out determination of remaining ink volume in the ink cartridges 101, 102 in accordance with an instruction sent from the main controller 40 via the bus BS. First, at time t0, the switch SW1 will be switched from the Off state to the On state, and one of the ink cartridges 101, 102 will be selected by the switch SW2. As a result, the sub-controller 50 and one of the oscillator circuits 110 of the ink delivery device 100 will be connected via a second sensor signal line LSP regardless of which of the ink cartridges 101, 102 has been selected. That is, regardless of which ink cartridge 101, 102 the sub-controller 50 has selected, a driving signal DS will be applied to the oscillator circuit 110, and the response signal RS will be output from the oscillator circuit 110.

From time t1 to t2 (application interval Dv), the driving signal DS will be presented to the sensor, and voltage will be applied to the piezoelectric element. During the application interval Dv, the third switch SW3 will be set to the Off state. As illustrated, the driving signal DS will include two pulse signals S1, S2 for example.

At time t2, the first switch SW1 will be switched to the Off state, and presentation of the driving signal DS to the oscillator circuit 110 will cease. Subsequent to time t2, the oscillator circuit 110 will oscillate at frequency H1 which indicates that remaining ink is present, and the response signal RS will be output from the sensor.

At time t3 which follows time t2 by a brief time interval, the third switch SW3 will be switched to the On state. At this time, the response signal RS from the oscillator circuit 110 will be presented to the comparator 52. The comparator 52 will compare the response signal RS and the reference voltage Vref, and output an H level or L level signal QC.

During an interval Dm (measurement interval Dm) starting at time t3, the logic portion 58 of the sub-controller 50 will set the counter 54 to the enabled state, and will measure the time needed for five pulses to be output from the comparator 52 (measurement interval Dm). Specifically, the logic portion 58 will measure the measurement interval Dm by counting the number of pulses of the clock signal that arise during the interval that five pulses are counted by the counter 54, i.e. the interval from the time that the rising edge of the first pulse is counted to the time that the rising edge of the sixth pulse. Once the counter 54 has counted the rising edge of the sixth pulse, the logic portion 58 will set the counter 54 to the disabled state. Then, on the basis of the measured measurement interval Dm and the number of pulses (five) of the output signal QC that were counted by the counter 54, the logic portion 58 will calculate the frequency Hc (=5/Dm) of a first signal component which is included in the response signal RS. As mentioned previously, the calculated frequency Hc represents the frequency of oscillation of the oscillator circuit 110. The number of measured pulses is not limited to five, and the number can be set appropriately.

For purposes of comparison, an instance in which the expected ink cartridges have been installed in the printer 200 of Embodiment 1 will be discussed.

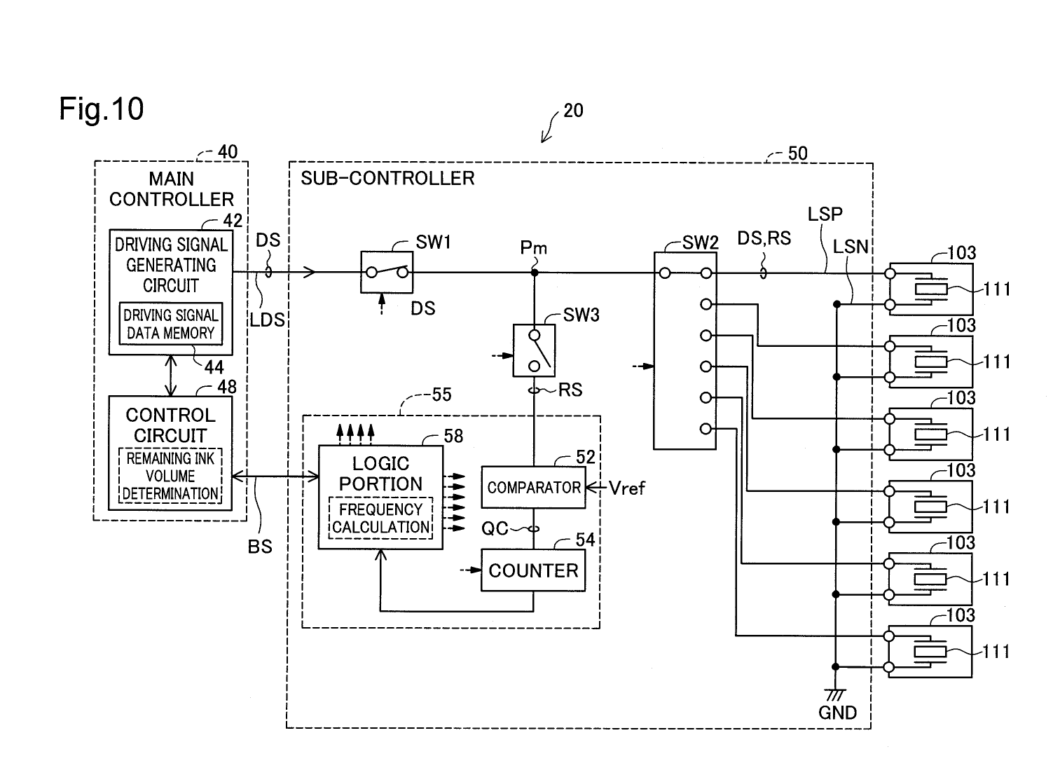

FIG. 10 is an illustration depicting an electrical configuration of a printing system in a comparative example. The configuration on the printer 20 side in FIG. 10 (the main controller 40 and sub-controller 50) is identical to the configuration shown in FIG. 8. In the printing system according to this comparative example, the ink delivery device 100 is replaced by six independent ink cartridges 103 that have been installed in the print head unit 60. Each of the ink cartridges 103 is provided with a board of a second type 120B (FIG. 5) and a piezoelectric element 111 constituting a remaining ink volume sensor.

The piezoelectric element 111 is connected at one electrode thereof to a first oscillator circuit connection terminal NT of the second type of board 120B of the ink cartridge 103, and at its other electrode to the second oscillator circuit connection terminal PT of the second type of board 120B. The remaining ink volume sensor is disposed in proximity to the ink delivery port 150. While not illustrated in detail in the drawing, the remaining ink volume sensor comprises a cavity that defines part of an ink passage in proximity to the ink delivery portion; an oscillator plate that defines part of the wall face of the cavity; and a piezoelectric element 111 arranged on the oscillator plate. By presenting the piezoelectric element with the sensor driving signal DS, the printer 20 (the main controller 40 and the sub-controller 50) can bring about oscillation of the oscillator plate through the agency of the piezoelectric element 111. By subsequently sensing, via the piezoelectric element 111, the response signal RS that is produced by residual vibration of the oscillator plate, the printer 20 can sense whether ink is present in the cavity. Specifically, when the condition inside the cavity changes from an ink-filled condition to an air-filled condition due to consumption of the ink contained in the ink cartridge 103, the characteristics of residual vibration of the oscillator plate will change as well. By sensing this change in oscillation characteristics through the agency of the piezoelectric element 111, the printer 20 can sense whether ink is present in the cavity. In other words, if a prescribed volume or more of ink is present in the ink cartridge 103, the frequency Hc of the response signal RS from the piezoelectric element 111 will be substantially equal to the first oscillation frequency H1, whereas if less than the prescribed volume of ink is present in the ink cartridge 103, the frequency Hc of the response signal RS from the piezoelectric element 111 will be substantially equal to the first oscillation frequency H2. Consequently, on the basis of the calculated frequency Hc, the first control circuit 48 of the main controller 40 will be able to correctly determine whether a prescribed volume or more of ink is present inside the selected ink cartridge 103.

From the above discussion it will be appreciated that the printer 20 of Embodiment 1, while assuming the use of an ink cartridge having an on-board sensor like the ink cartridge 103 shown in the comparative example, is able to operate normally even where the ink delivery device 100 according to Embodiment 1 has been installed. Since the ink delivery device 100 does not require that the ink cartridges 101, 102 have on-board sensors that include a piezoelectric element, the design can be simpler and the number of parts can be reduced. The oscillator circuit 110 of Embodiment 1 can be termed a ‘sensor simulating-circuit’ that outputs as its response signal RS a signal indicating that ink is present in the ink cartridges 101, 102.

Additionally, because the six ink cartridges 101, 102 share a single oscillator circuit 110, the number of parts can be reduced further. Also, by providing wire length adjustment portions RL, RL1, RL1 in the oscillator circuit 110 and its wiring, there can be devised an oscillator circuit 110 that appears equivalent to the ink cartridges 101, 102. As a result, the response signal RS indicating that ink is present can be accurately output to the printer 20.

### B. Embodiment 2

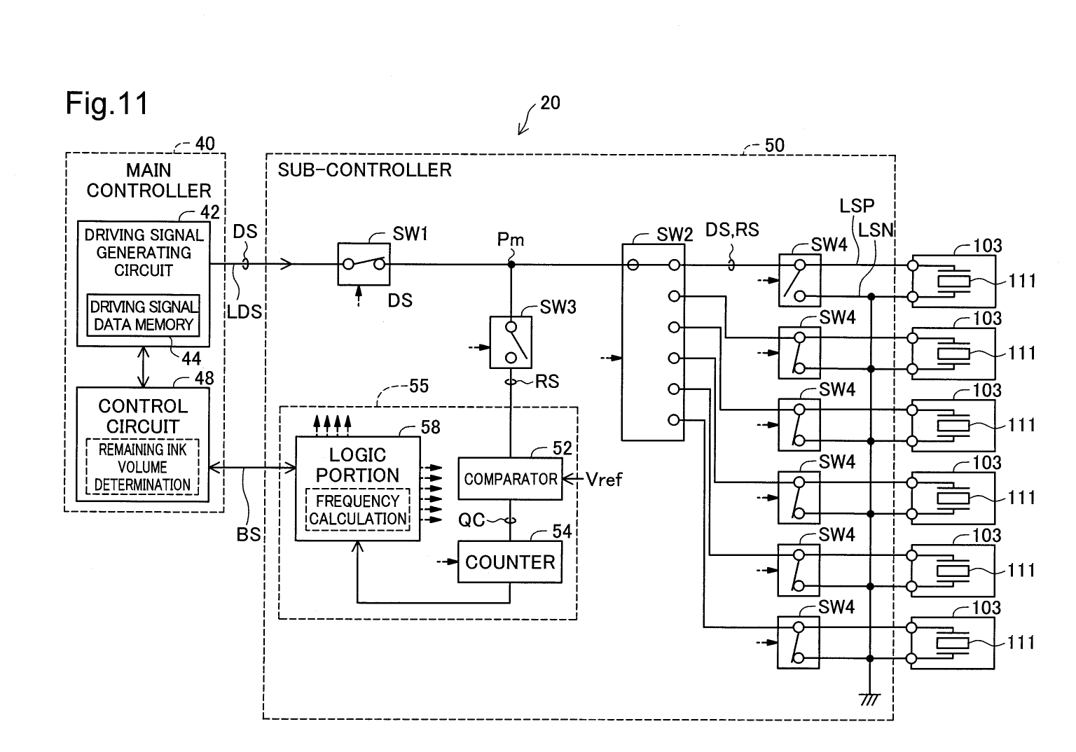

In Embodiment 2, a different printer is used in the printing system, so the discussion will proceed from the configuration of the printer. FIG. 11 is a diagram depicting an electrical configuration of a printer 20A in Embodiment 2. The printer 20A of Embodiment 2 is assumed to use ink cartridges equipped an on-board sensor, like the ink cartridges 103 discussed earlier. To aid understanding, FIG. 11 depicts the sensor-equipped ink cartridges 103 installed.

The printer 20A of Embodiment 2 differs from the printer 20 of Embodiment 1 in terms of the sub-controller configuration. In addition to the arrangements of the sub-controller 50 of Embodiment 1, the sub-controller 50A of Embodiment 2 is provided with fourth switches SW4 in a number corresponding to the number of installable ink cartridges, i.e. six in the case of the present embodiment.

The fourth switches SW4 are single-channel analog switches. Each of the six fourth switches SW4 is connected at the terminal on one side thereof to one of six terminals on the other side of the second switch SW2; and when the ink cartridge 103 is installed in the print head unit 60, will connect to a first sensor signal line LSN via the first oscillator circuit connection terminal CN of the ink cartridge 103. The other terminal of each fourth switch SW4 is supplied with ground potential GND. Other arrangements are the same as in the sub-controller 50 of Embodiment 1 depicted in FIGS. 8 and 10.

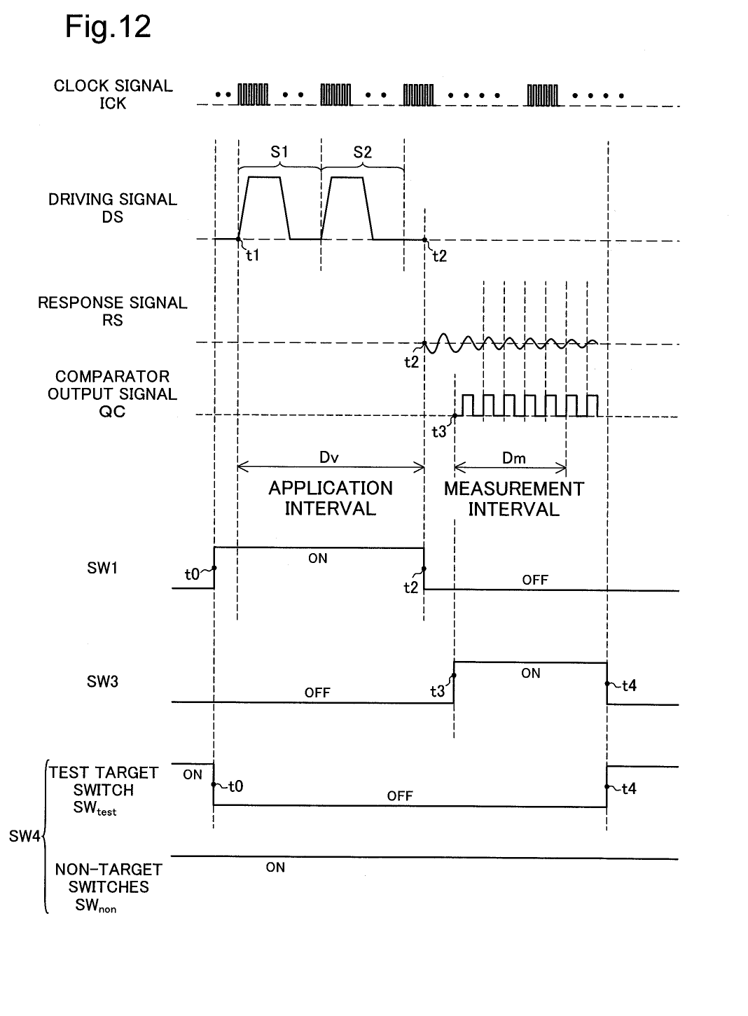

FIG. 12 is a first timing chart in the case of measurement of response signal RS frequency in Embodiment 2. Operation of the fourth switches SW4 is depicted separately for a test target switch SWtest and non-target switches SWnon. The test target switch SWtest is the one switch among the six fourth switches SW4 that is connected to the ink cartridge 103 selected by the second switch SW2. The non-target switches SWnon are the five switches that of the six fourth switches SW4 are those respectively connected to the five ink cartridges 103 not selected by the second switch SW2. The logic portion 58 will place in the Off state the fourth switch SW4 that is connected to the one selected test target, and place in the On state the fourth switches SW4 that are connected to the other five ink cartridges 102. During the remaining ink volume sensing process inclusive of the sensor driving signal DS application interval Dv and the frequency Hc measurement interval Dm, the logic portion 58 will set the test target switch SWtest to the Off state and the non-target switches SWnon to the Off state. Consequently, the sub-controller 50 and the selected ink cartridge 102 will be able to exchange the driving signal DS and the response signal RS via the first sensor signal line LSN. Meanwhile, the first sensor signal lines LSN connecting the sub-controller 50 and the non-selected ink cartridges 103 will be held at ground potential GND. This is done in order to limit noise emitted by the piezoelectric elements 111 of the non-targeted ink cartridges 103, and to stabilize exchange of signals between the sub-controller 50 and the piezoelectric element 111 targeted for determination of remaining ink volume.

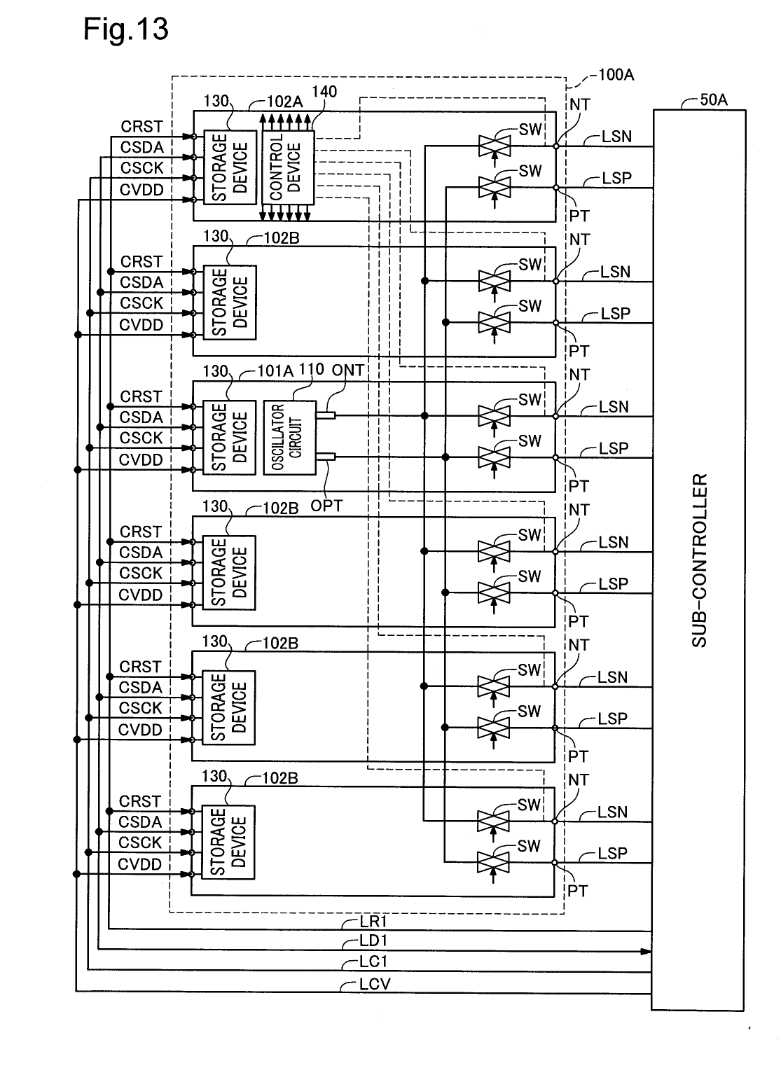

FIG. 13 is an illustration depicting a configuration of the ink delivery device 100A in Embodiment 2. The difference between the ink delivery device 100A of Embodiment 2 and the ink delivery device 100 of Embodiment 1 is that each ink cartridge 101A, 102A, 102B is furnished with two switches SW (hereinafter termed cartridge switches). The cartridge switches SW are single-channel analog switches. One of these cartridge switches SW is provided between the first external connection terminal ONT of the oscillator circuit 110 and the first oscillator circuit connection terminal NT of each ink cartridge 101A, 102A, 102B, while another one of the cartridge switches SW is provided between the second external connection terminal OPT of the oscillator circuit 110 and the second oscillator circuit connection terminal PT of each ink cartridge 101A, 102A, 102B. The ink cartridge 102A is provided with a control device 140 for controlling the total of twelve switches SW. The control device 140 normally places the cartridge switches SW in the Off state (nonconductive state).

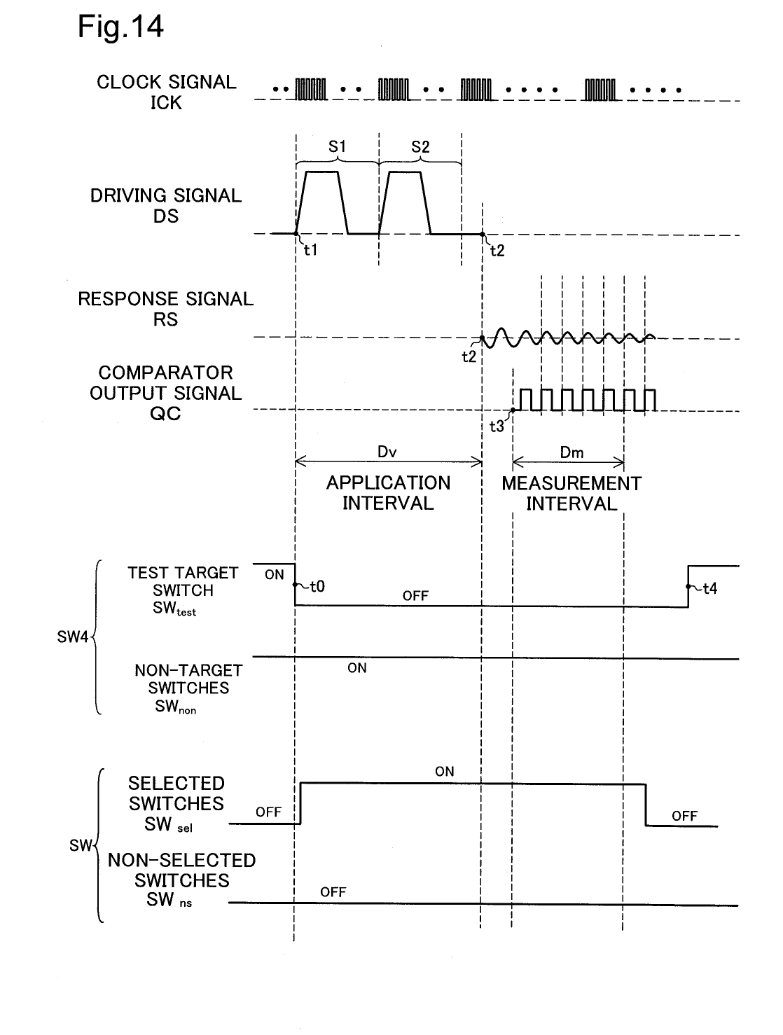

FIG. 14 is a second timing chart in the case of measurement of response signal RS frequency in Embodiment 2. During the remaining ink volume sensing process inclusive of the sensor driving signal DS application interval Dv and the frequency Hc measurement interval Dm, the control device 140 will switch selected switches SWsel to the On state (conductive state) while maintaining non-selected switches SWns in the Off state (nonconductive state). The selected switches SWsel will be the two cartridge switches on board the cartridge that has been selected as the remaining ink volume test target (test target cartridge) from among the six ink cartridges 101A, 102A, 102B by the printer 20A (sub-controller 50). The non-selected switches SWns will be the other 10 switches from among the twelve cartridge switches, except for the selected switches SWsel. Here, the control device 140 will constantly monitor potential on the first oscillator circuit connection terminals NT of the ink cartridges 101A, 102A, 102B. When the potential on any of the first oscillator circuit connection terminals NT has reached a prescribed threshold value or above, the control device 140 will designate as selected switches SWsel the two cartridge switches SW that are on board the ink cartridge to which the first oscillator circuit connection terminal NT belongs, and will selectively place these switches in the On state. As a result, as depicted in FIG. 14, the two cartridge switches SW of a test-targeted cartridge will assume the On state at the instant that the test-targeted cartridge in question is selected and the sensor driving signal DS is input. As a result, the input sensor driving signal DS will be applied to the oscillator circuit 110 regardless of which of the six ink cartridges 101A, 102A, 102B has been selected as the test target. Then, a response signal from the oscillator circuit 110 in response to the sensor driving signal will be transmitted to the sub-controller 50 via the first oscillator circuit connection terminal NT of the test-targeted cartridge. The selected switches SWsel which have been placed in the On state will return to the Off state at suitable time when the remaining ink volume sensing process has finished.

As will be appreciated from the preceding description, the printer 20A of Embodiment 2 above, while assuming the use of an ink cartridge having an on-board sensor like the ink cartridge 103 shown in the comparative example, is able to operate normally even where the ink delivery device 100A according to Embodiment 2 has been installed. Since the ink delivery device 100A does not require that the ink cartridges 101A, 102A, 102B have on-board sensors that include a piezoelectric element, the design can be simpler and the number of parts can be reduced. Additionally, because the six ink cartridges 101A, 102A, 102B share a single oscillator circuit 110, the number of parts can be reduced further.

### C. Modified Embodiments

### Modified Embodiment 1

While the ink delivery devices 100, 100A in the preceding embodiments employ an oscillator circuit 110 as the electrical device for returning the response signal RS to the sensor driving signal DS, a sensor that includes a piezoelectric element 111 could be provided instead. In this case, if an ink cartridge of the first type 101 equipped with the sensor contains ink, the printer 20 will decide that all of the ink cartridges contain ink. Accordingly, the printer 20 will operate normally even if this type of ink delivery device is installed. Since the sensor (piezoelectric element 111) is shared by the six ink cartridges, the number of parts can be reduced as well.

### Modified Embodiment 2

While the ink delivery devices 100, 100A in the preceding embodiments are composed of six ink cartridges, they could be composed of any number N (where N is an integer≧2) of ink cartridges. For example, the ink cartridges may be equal in number to the number of ink receiving needles 61 of the printer in which the device will be installed: for a four-color printer, the device might be composed of four ink cartridges. Also, ink cartridges may be smaller in number than the number of ink receiving needles 61 of the printer in which the device will be installed: for a six-color printer, the device might be composed of three ink cartridges.

### Modified Embodiment 3

In the ink delivery devices 100, 100A of the preceding embodiments, the single oscillator circuit 110 is shared by six ink cartridges, but instead the single oscillator circuit 110 could be shared by three ink cartridges. In this case, a single ink delivery device will have two on-board oscillator circuits 110. In general, a single oscillator circuit 110 may be shared by any number M of ink cartridges from among any number N of ink cartridges (where M is an integer equal to 2 or greater but not greater than N).

### Modified Embodiment 4

In the ink delivery devices 100, 100A of the preceding embodiments, the six ink cartridges are joined, but instead six physically separate chambers could be respectively disposed inside a single housing to make up a single ink delivery device. In either case, the N ink-containing portions (ink cartridges or ink-containing chambers etc.) and the ink delivery apertures that communicate with these ink-containing portions will correspond to the ink delivery portions in the Claims.

### Modified Embodiment 5

While the ink delivery devices 100, 100A of the preceding embodiments have six circuit boards, they could be designed with a single circuit board instead. In this case, all of the lines depicted in FIG. 6 would be made on the circuit board.

### Modified Embodiment 6

In the ink delivery devices 100, 100A of the preceding embodiments, lines on the circuit boards include wire length adjustment portions RL, RL1, RL2, but these could be omitted.

### Modified Embodiment 7

In the ink delivery devices 100, 100A of the preceding embodiments, the circuit boards 120A, 120B are installed on the ink cartridges which are provided as ink receptacles for containing the ink; however, the ink receptacles and the circuit boards 120A, 120B could instead be provided as discrete elements that are completely separate physically. For example, a plate having the circuit boards 120A, 120B mounted thereon could be attached to the print head unit 60 by a prescribed fastening fitting and electrically connected with the sub-controller 50, while the ink receptacles situated at a different location are connected to the ink receiving needles 61 of the print head unit 60 by flexible tubes.

### Modified Embodiment 8

In the preceding embodiments, a single ink tank is constituted as a single ink cartridge 101, but it would be possible for a plurality of ink tanks to be constituted as a single ink cartridge 101.

### Modified Embodiment 9

While an inkjet printer and ink delivery devices are employed in the preceding embodiments, it would also be acceptable to employ a liquid jetting device adapted to jet or eject a liquid other than ink, and liquid delivery devices adapted to contain such a liquid. Herein, the term liquid is used to include liquid-like matter containing particles of a functional material dispersed in a medium; or fluid-like matter of gel form. For example, there could be employed liquid jetting devices adapted to jet a liquid that contains an electrode material, coloring matter, or other matter in dispersed or dissolved form used in the manufacture of liquid crystal displays, EL (electroluminescence) displays, field emission displays, or color filters; liquid jetting devices adapted to jet biooorganic substances used in biochip manufacture; or liquid jetting devices adapted to jet liquids as specimens used as precision pipettes. Additional examples are liquid jetting devices for pinpoint jetting of lubricants into precision instruments such as clocks or cameras; liquid jetting devices adapted to jet an ultraviolet-curing resin or other transparent resin solution onto a substrate for the purpose of forming a micro semi-spherical lens (optical lens) for use in optical communication elements etc.; or liquid jetting devices adapted to jet an acid or alkali etchant solution for etching circuit boards, etc. The present invention can be implemented in any of the above types of jetting devices and liquid delivery devices for these liquids.

### Modified Embodiment 10

Some of the arrangements that have been implemented through hardware in the preceding embodiments may instead be implemented through software, and conversely some of the arrangements that have been implemented through software may instead be implemented through hardware.

While the present invention has been shown herein in terms of certain preferred embodiments and modified embodiments, the present invention is not limited to these embodiments and their modifications, and may be embodied in various modes without departing from the spirit thereof.

What is claimed is:

1. A liquid delivery device adapted for installation in a liquid jetting device that has a number N of liquid receiving portions, where N is an integer equal to 2 or greater, comprising:
an electrical device that returns a response signal in response to a driving signal from the liquid jetting device;
a number N of liquid delivery portions that deliver liquid to the liquid receiving portions; and
a number N of sets of terminals provided in correspondence with the liquid delivery portions;
wherein the electrical device receives the driving signal and transmits the response signal, via one set of terminals among a number M of sets of terminals among the N sets of terminals, where M is an integer equal to 2 or greater but not greater than N.

2. The liquid delivery device according to claim 1, wherein
the M sets of terminals are electrically connected in parallel to the electrical device.

3. The liquid delivery device according to claim 1, further comprising switches that selectively connect one set of the M sets of terminals to the electrical device.

4. The liquid delivery device according to claim 1, further comprising switches that produce a state of electrical continuity between the electrical device and one selected set of terminals among the M sets of terminals, while producing a state of electrical discontinuity between the electrical device and the other of the M sets of terminals.

5. The liquid delivery device according to claim 1, wherein
the electrical device includes a sensor-simulating circuit that, without sensing whether liquid is present in the liquid delivery portions, will output a signal indicating that liquid is present in the liquid delivery portions as the response signal.

6. The liquid delivery device according to claim 5, wherein
the sensor-simulating circuit includes an oscillator circuit.

7. The liquid delivery device according to claim 1, wherein
the electrical device includes a sensor that outputs different signals as the response signal, depending on whether the liquid is present in the liquid delivery portions.

8. The liquid delivery device according to claim 7, wherein
the sensor includes a piezoelectric element.

9. The liquid delivery device according to claim 1, wherein
wired connections are provided between the electrical device and a first set of terminals among the M sets of terminals, and between the electrical device and a second set of terminals among the M sets of terminals; and
wiring distance between the electrical device and the first set of terminals is equal to wiring distance between the electrical device and the second set of terminals.

10. The liquid delivery device according to claim 1, wherein
the number M is equal to the number N, and
the electrical device individually receives the drive signal and transmits the response signal, via any one set of terminals among the N sets of terminals.

11. An electrical circuit adapted for installation in a liquid jetting device that has a number N of liquid receiving portions, and a number N of sets of device-side terminals provided in correspondence with the liquid receiving portions, where N is an integer equal to 2 or greater, the electrical circuit comprising:
an electrical device that returns a response signal in response to a driving signal from the liquid jetting device; and
a number M of sets of circuit-side terminals that electrically connects respectively to M sets of terminals among the N sets of device-side terminals when installed in the liquid jetting device, where M is an integer equal to 2 or greater;
wherein the electrical device receives the driving signal and transmits the response signal, via one set of circuit-side terminals among the M sets of circuit-side terminals.

12. A liquid jetting system comprising:
a liquid jetting device; and
an ink delivery device adapted for installation in the liquid jetting device;
wherein the liquid jetting device has:
a number N of liquid receiving portions where N is an integer equal to 2 or greater;
a number N of sets of device-side terminals provided in correspondence with the liquid receiving portions; and
a sensor driving circuit that outputs a driving signal from any terminal of one set of terminals selected from the N sets of device-side terminals, and receives a response signal from any terminal of the selected one set of terminals;
the ink delivery device has:
an electrical device that returns a response signal in response to the driving signal; and
a number M of sets of delivery device-side terminals that electrically connects respectively to M sets of terminals among the N sets of jetting device-side terminals when the ink delivery device is installed in the liquid jetting device, where M is an integer equal to 2 or greater;
and wherein the electrical device receives the driving signal and transmits the response signal, via one set of delivery device-side terminals among the M sets of delivery device-side terminals.
